(19) United States
(12) Patent Application Publication
(10) Pub. No.: US 2009/0064548 A1
(43) Pub. Date: Mar. 12, 2009

(54) EAR TAG FOR IDENTIFYING ANIMALS

(75) Inventor: Joan Francesc Vilaseca Vintro, Esplugues De Llobregat (ES)

Correspondence Address: SUGHRUE MION, PLLC, 2100 PENNSYLVANIA AVENUE, N.W., SUITE 800, WASHINGTON, DC, 20037, US

(73) Assignee: Rumitag, S.L., Esplugues De Llobregat (ES)

(21) Appl. No.: 12/159,823

(22) PCT Filed: Dec. 20, 2006
(86) PCT No.: PCT/EP06/12297

§ 371 Date: Jul. 1, 2008

(30) Foreign Application Priority Data
Jan. 10, 2006 (ES) P 200600047

(51) Int. Cl. A01K 11/00

(52) U.S. Cl. 40/302

(57) ABSTRACT

Ear tag for identifying animals, which consists of two parts comprising a male element, with a protrusion designed to pass, in the tag's operative position, through the cartilage of an animal's ear, and a female element, mutually couplable, leaving the tag suspended with room for manoeuvre, in the operative position, from the animal's ear by the protrusion of the male element, with one of the elements male or female having an electronic identification device encapsulated and lodged in a corresponding oblong receptacle, solidly joined to the male or female part in which said device is fitted, forming a sharp angle of between 10° and 45° in relation to the horizontal plane, in the abovementioned operative position of the tag.

### TECHNICAL FIELD OF THE INVENTION

The invention relates to an ear tag for identifying animals, which consists of two distinct parts or pieces and comprising a female element and a male element that can be mutually coupled, of which the male element is fitted with a protrusion that acts as a slide and is designed to pass, in the tag's operational position, through the cartilage of an animal's ear, leaving the tag hanging from the animal's ear from the male element's protrusion. For the purpose of automatically obtaining information on the animal, the tag is equipped with an encapsulated electronic identification device lodged in the corresponding receptacle.

### BACKGROUND OF THE INVENTION

Currently, a large variety of ear tags for identifying animals are known, especially for automatic identification of cattle and farm animals, which incorporate an electronic identification device or transponder, with a data memory that can be read without contact, via radio waves using antennas. These antennas transmit and/or receive a radio signal that activates the tags' electronic devices within the reading field, causing them to reflect their information on a reader associated to the antenna.

Among the different types of transponders used in the field of controlling animals on a stock or breeding farm, usually passive-type transponders are used, which do not require batteries and use the energy received from the reading antenna to transmit their data, which are of minimum cost and a reduced size, capable of being incorporated in an ear tag. These transponders also tend to be of the read-only type, which are programmed during their manufacture, or prior to their first use, with a single identification code that cannot be changed. When the antenna transmits or creates an energy field that interrogates the transponder and provides it with the required energy to operate, the latter reflects the information it contains, which is captured and interpreted by a reader.

In terms of transponder format, particularly relevant ones are those that consist of microchips and the corresponding dipolar omnidirectional antennas, lodged in cylindrical airtight capsules made of a material that does not distort the electromagnetic radiation field, such as glass, which can be subcutaneously implanted in the animals or that can also be lodged in compartments provided for this purpose in the ear tags, or in biocompatible sealed receptacles designed to be ingested by the animals.

The omnidirectional bipolar antennas extend in one direction only, which means that their orientation significantly affects the reading of the transponder. The capsules' best orientation varies according to the type of antenna used by the readers, usually linear or circular, because the type determines the propagation field of the signal they emit.

The abovementioned drawback greatly affects normal reading procedures of the transponders incorporated in animals' ear tags, since the two main methods of reading that are put into practice differ considerably. In the first instance, to automatically read the transponders, the readers' antennas are installed in strategic places that animals are forced to pass through. In particular, the animals are made to pass through narrow corridors on the walls of which the reading equipment antennas are fitted, capable of activating the transponders at approximate distances of 100 cm. For this purpose, it has been shown that the transponders' best position is horizontal. This position guarantees good reading distances due to, among other reasons, the fact that it increases the number of times that the antennas of the readers interrogate or activate the transponders.

U.S. Pat. No. 5,461,807 discloses an ear tag that comprises a male element and a female element that can be mutually coupled, with the female part provided with an orifice designed to hold and allow passage of the protrusion of the male element, which determines the axis for supporting the tag. The female part is provided additionally with a prolongation in the form of a flat plate equipped with an elongated receptacle adapted to lodge tightly an encapsulated transponder of the type described earlier, which is arranged in parallel with respect to the horizontal plane that passes through the abovementioned hanging axis of the tag in its operative position.

In a similar fashion, patent document EP 1084614 discloses a comparable tag from which, in an immovable manner and before the coupling between the male and female parts, an accessory body is suspended provided with an elongated receptacle to lodge the transponder, leaving said receptacle arranged in the tag's operative position parallel with respect to the horizontal plane that passes through the hanging axis of the tag in the animal's ear.

Patent document NL 1008869 discloses an ear tag of the type disclosed in the previous documents, which incorporates in the flat plate-shaped extension of the female part an elongated receptacle that can be opened through elastic deformation of the flat plate designed to lodge tightly the transponder. The tag's receptacle is arranged analogously to the tags of the previous documents, in such a way that it is predominantly horizontal when the tag is in its operative position applied to the ear of an animal.

Unlike the tags described previously, in which the receptacles extend over a plane perpendicular to the hanging axis of the tags, in patent document WO 9504455 the receptacle, which is arranged in the male element, is aligned with said hanging axis, and is also left in a horizontal position when the tag is applied to the ear of an animal.

The second mode of reading in use is manual and is performed with portable equipment. These devices are provided with a linear antenna that an operator can hold, and whose free end must come close to the ear of the animal carrying the ear tag. To prevent accidents and not harm the animal with the antenna, the operator stands near the animal and from above aims the antenna's free end in the direction of the ear tag. However, due to the transponders' usually horizontal position, the reading field is much reduced meaning that the end of the antenna has to come very close to the transponder, and even touch the ear tag in which it is lodged. To improve the reading of the transponders in manual mode, the theoretical ideal arrangement of the transponders is one in which the transponder is aligned with the antenna. In this case, since the antenna is aimed from above, an arrangement that is considered is one in which the transponder is vertical with the tag is in its operative position. In this case, an ear tag such as the one disclosed in patent document WO 2004/017723, in which the receptacle that lodges the transponder is arranged in the female part, perpendicularly in relation to the hanging axis of the tag in its operative position, would prevent having to move the end of the antenna close to the transponder until almost establishing contact with the ear tag. However, despite the fact that this facilitates reading with portable equipment, the transponder's vertical orientation significantly reduces the reading distance in automatic mode, using fixed antennas, for which the optimum orientation is horizontal.

For all the foregoing, there is an evident need for an ear tag of the type provided with an encapsulated electronic identification device lodged tightly in its corresponding receptacle, having an optimum configuration to facilitate reading of said electronic device both manually, using portable equipment, and automatically, without significantly affecting the weight of the tag and the cost of manufacturing it.

### EXPLANATION OF THE INVENTION

The ear tag for identifying animals that is the object of this invention which consists of two distinct parts or pieces comprising a male element fitted with a protrusion that is designed to pass, in the tag's operational position, through the cartilage of an animal's ear, ending in a head preceded by a perimeter step, and a female element, which includes an aperture with means for retaining the male part's head, with the male element and female element capable mutually couplable by making the end head of the male element's protrusion pass through the abovementioned aperture in the female element, leaving the tag suspended with room for manoeuvre, in the tag's operative position, from the animal's ear by the male element's protrusion, which determines the tag's hanging axis. According to the tag of the invention, one of the elements, either male or female, is fitted with an encapsulated electronic identification device lodged in its corresponding oblong receptacle.

Essentially, the tag is characterized in that this oblong receptacle is solidly joined to the male or female part in which the electronic identification device is fitted and is arranged inclined, forming a sharp angle in relation to the horizontal plane, in the tag's abovementioned operative position.

Preferably, the receptacle, and thus the electronic identification device lodged in it, is inclined between 10° and 45° in relation to the horizontal plane in its operative position.

Of all the possible orientations and according to a particularly interesting embodiment, the oblong receptacle, and thus the electronic identification device lodged in it, extends over a normal imaginary plane to the tag's hanging axis in its operative position.

### BRIEF DESCRIPTION OF THE DRAWINGS

The attached drawings show, by way of illustration but not limitation, two variants of the tag according to the invention. In said drawings:

FIG. 1 is a front elevation view of a way of realizing the female part of the tag according to the invention, in its operative position;

FIG. 2 is a perspective view of the female part according to the form of embodiment of FIG. 1; and

FIG. 3 is a perspective view of a second form of embodiment of the female part of a tag according to the invention.

### DETAILED DESCRIPTION OF THE DRAWINGS

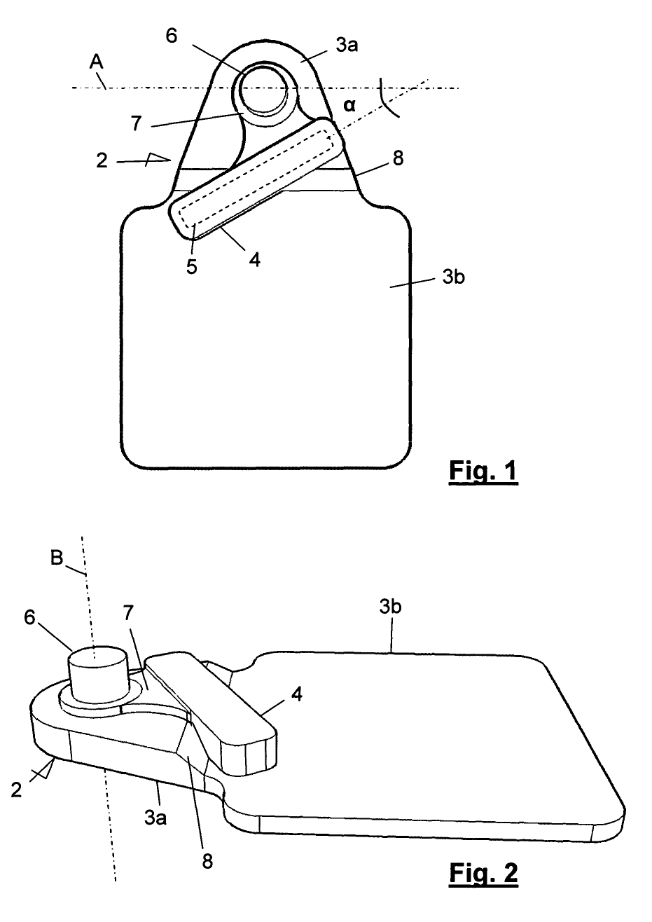

FIGS. 1 to 3 show the female part of an ear tag consisting of two parts, male and female, separate, and mutually couplable.

Female part 2 of the ear tag of FIG. 1 has been represented in its theoretical operative position. In this position, the tag is suspended from the animal's ear by the protrusion of the male part, which is not represented, in such a way that the female part 2 extends vertically.

Female part 2 is obtained by modelling and, as can be seen from FIG. 1, comprises a lower portion in the form of a flat plate 3b, which serves as a support for a visual representation of information, such as an alphanumeric code or barcode, and an upper portion 3a that is narrower and more rounded, although thicker, which incorporates a casing 6 provided with an aperture with retaining means, destined to receive and retain the head of the protrusion of the male part of the tag. This casing 6, made using a rigid plastic material, is embedded as the upper portion 3a is moulded around it, leaving it solidly joined to the female part 2 of the tag, usually made of a flexible synthetic material especially to prevent animals injuring themselves with the portion in the form of a flat plate 3b and also to prevent accidental breakage.

The lower portion in the form of a flat plate 3b and the upper portion 3a are moulded together and are therefore joined gap free by an intermediate portion 8 with a decreasing longitudinal section given the difference in thickness between the upper portion 3a and the one corresponding to the flat plate 3b.

The greater thickness of the upper portion 3a gives the female part of the tag greater rigidity in this zone and prevents that starting from the tag's operative position, said portion can bend on itself with a view to making it pass, bent over, through the perforation made in the cartilage of the animal's ear, originally penetrated by the protrusion of the male element, and thus be able to extract the ear tag in this way.

With regards to the casing 6, when it is configured as a hood to envelop and protect the head of the male part's protrusion it may be totally covered by the material that constitutes the female part 2 of the tag or may be left partially exposed.

The female part 2 is provided with an oblong receptacle 4, straight and elongated, designed to lodge, preferably tightly, an electronic device 5 of the type consisting of a microchip and its corresponding omnidirectional dipolar antenna, lodged in a sealed and essentially cylindrical capsule. The size, and particularly the length, of the oblong receptacle 4, depends on the length of the electronic device, which is usually between 23 and 32 mm.

As can be seen from FIG. 1, the oblong receptacle 4, and thus the electronic device 5 that it lodges, is arranged inclined, forming a sharp angle α of 30° in relation to the horizontal plane that passes through the tag's hanging axis, indicated with letter A in FIG. 1.

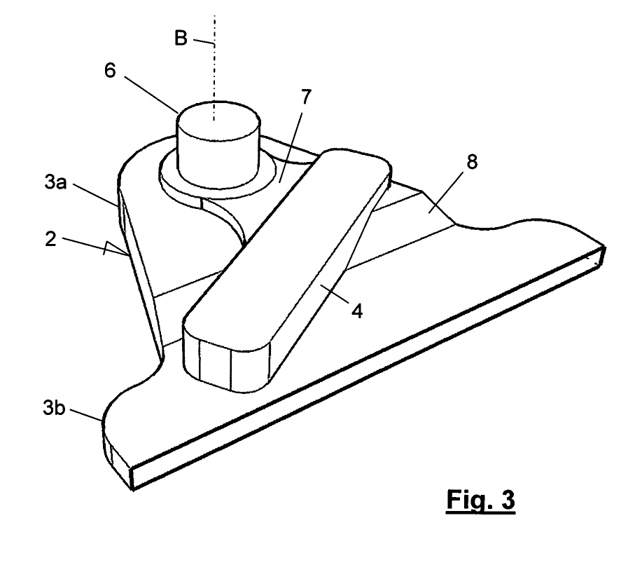

The oblong receptacle 4 extends diagonally from the lower part of upper portion 3a, just under casing 6, to the upper part of the flat plate 3b. As can be seen from FIG. 2, the oblong receptacle 4 is configured in such a way that the electronic device lodged within it extends over a normal imaginary plane to the abovementioned hanging axis of the tag, indicated with arrow B in FIG. 2, or similarly, the electronic device extends in parallel with respect to the flat plate 3b.

FIGS. 1 and 2 also show that the female part 2, and specifically its upper portion 3a, is fitted with a reinforcing portion 7, thicker than the rest of the upper portion 3a, which projects with an edge from its surface, that connects the zone of the casing 6 and the receptacle 4. In particular, said reinforcing section 7 comprises a first ring-shaped zone, which surrounds casing 6, and a second zone that extends in the direction of receptacle 4 until it joins said receptacle 4. This reinforcement portion is designed to further reinforce female part 2 of the tag, especially the portion that contains the electronic device 5, to prevent this portion becoming easily bent making the electronic device 5 inoperative, all of the above without increasing too much the weight of the female part 2 of the tag.

FIG. 3 shows female part 2 of a very similar tag to the ones of FIGS. 1 and 2. This female part 2 differs from the previous ones in that it does not have flat plate 3b, and its size is much smaller.

It is important to point out that there are innumerable possible positions or orientations for receptacle 5 in the male or female part of a tag according to the invention. Indeed, the receptacle can be oriented in all possible positions, inscribed in a sphere whose centre coincides with the middle point of the receptacle.

Additionally, it should be taken into account that the operative position represented in FIG. 1 is just a theoretical operative position, since the tag is applied to the animal's ear, suspended by the protrusion of the male part, which determines the tag's hanging axis B, with room for manoeuvre. In other words, the tag, with the animal's movements of the ear, or by contact and rubbing against external elements such as other animals, gates or bushes, can rotate slightly around its hanging axis B (see FIGS. 2 and 3).

With all of the above, of the infinity of possible orientations, the position represented in FIGS. 1 to 3, in which the receptacle extends over a parallel plane to plate 3b and inclined, forming a sharp angle α in relation to the imaginary plane A (see FIG. 1), the reading distance in manual mode, using portable equipment, increases surprisingly, without reducing the reading distance in automatic mode. The orientation described above additionally makes it possible to position the receptacle in the male or female part of the tag, in a place that does not excessively complicate its manufacture, meaning that there is no increase in either the cost of making it or its weight.

Naturally, although only the female part 2 of the tag according to the invention is represented, it is understood that if the oblong receptacle 4 were to be located in the male part, it would be arranged analogously to the represented embodiment, just under the protrusion, which would be arranged in the place of casing 6, and inclined between 10° and 45° with respect to the horizontal plane in the tag's operative position.

1. Ear tag for identifying animals that consists of two distinct parts or pieces comprising
a male element, with a protrusion designed to pass, in the tag's operative position, through the cartilage of an animal's ear, with the protrusion having a head at one end preceded by a perimeter step, and
a female element (2), which includes an aperture with means for retaining the head of the male part's protrusion,
in such a way that the male element and the female element are mutually coupled when the head of the male element is made to pass through the abovementioned aperture in the female element, leaving the tag suspended with room for manoeuvre, in the operative position, from the animal's ear by the protrusion of the male element, which determines the tag's hanging axis, and with the male element or female element having an electronic identification device (5) encapsulated and lodged in a corresponding oblong receptacle (4), characterized in that said receptacle is solidly joined to the male or female element that has the electronic identification device and forms a sharp angle α in relation to the horizontal plane (A), in its operative position.

2. Ear tag according to claim 1, characterized in that the oblong receptacle (4), and thus the electronic identification device (5) it lodges, is inclined at between 10° and 45° in relation to horizontal plane (A) in its operative position.

3. Ear tag according to the claim 1, characterized in that the oblong receptacle (4), and thus the electronic identification device (5) it lodges, extends over a normal imaginary plane to the tag's hanging axis (B), which is arranged predominantly horizontal in its operative position.
